(19) United States
(12) Patent Application Publication
(10) Pub. No.: US 2010/0173166 A1
(43) Pub. Date: Jul. 8, 2010

(54) FLUORINATED COMPOSITIONS AND SURFACE TREATMENTS MADE THEREFROM

(76) Inventors: Rudolf J. Dams, Antwerp (BE); Steven J. Martin, Shoreview, MN (US)

Correspondence Address: 3M INNOVATIVE PROPERTIES COMPANY, PO BOX 33427, ST. PAUL, MN, 55133-3427, US

(21) Appl. No.: 12/602,700

(22) PCT Filed: Jun. 5, 2008
(86) PCT No.: PCT/US08/65883

§ 371 Date: Dec. 2, 2009

Related U.S. Application Data
(60) Provisional application No. 60/942,399, filed on Jun. 6, 2007.

(51) Int. Cl. B32B 13/04; C07F 9/22; B32B 15/04; B32B 9/04; B32B 18/00; C09D 5/00

(52) U.S. Cl. 428/446; 562/15; 562/20; 428/457; 428/704; 106/287.25

(57) ABSTRACT

A composition represented by formula: (I) Rf is a monovalent or divalent perfluoropolyether group. Each R is independently selected from the group consisting of hydrogen and alkyl having from 1 to 4 carbon atoms. Each X is independently a divalent or trivalent group selected from the group consisting of alkylene, arylalkylene, and alkylarylene, wherein alkylene, arylalkylene, and alkylarylene are each optionally interrupted by at least one ether linkage. Each V is independently alkylene that is optionally interrupted by at least one ether linkage or amine linkage. Each Y is independently selected from the group consisting of hydrogen, alkyl, and a counter cation; y is 1 or 2; and z is 1 or 2. Methods of treating a surface using these compositions, formulations including these compositions, and articles with a surface in contact with these compositions are provided.

Rf—{C(O)—N(R)—X—[OC(O)—V—P(O)—(OY)₂]_{y}}_{z}. (I)

### BACKGROUND

Fluorochemicals have been used to provide properties such as hydrophobicity, oleophobicity, and stain resistance to various materials (e.g., ceramics, fabrics, and porous stones). The particular properties affected depend, for example, on the particular composition of the fluorochemical and the particular material treated with the fluorochemical.

Traditionally many widely used fluorochemical treatments included long-chain perfluoroalkyl groups, (e.g., perfluorooctyl groups). Recently, however, there has been an industry trend away from using perfluorooctyl fluorinated compounds, which has resulted in a desire for new types of fluorinated surface treatments.

### SUMMARY

In one aspect, the present invention provides a composition represented by formula:

Rf—{C(O)—N(R)—X—[OC(O)—V—P(O)—(OY)₂]_{y}}_{z},
wherein
   Rf is a monovalent or divalent perfluoropolyether group;
   each R is independently selected from the group consisting of hydrogen and alkyl having from 1 to 4 carbon atoms;
   each X is independently a divalent or trivalent group selected from the group consisting of alkylene, arylalkylene, and alkylarylene, wherein alkylene, arylalkylene, and alkylarylene are each optionally interrupted by at least one ether linkage;
   each V is independently alkylene that is optionally interrupted by at least one ether linkage or amine linkage;
   each Y is independently selected from the group consisting of hydrogen, alkyl, and a counter cation;
   y is 1 or 2; and
   z is 1 or 2.

In another aspect, the present invention provides a method of treating a surface, the method comprising contacting the surface with a composition according to the present invention.

In another aspect, the present invention provides a formulation comprising the composition according to the present invention and an aliphatic phosphonic acid, or an ester or a salt thereof, having from 1 to 30 carbon atoms and optionally at least one ether linkage, ester linkage, or amide linkage.

In another aspect, the present invention provides a formulation comprising the composition according to the present invention and solvent, wherein the solvent comprises at least one of a lower alcohol or a hydrofluoroether.

In another aspect, the present invention provides an article having a surface, wherein at least a portion of the surface is in contact with a composition represented by formula:

Rf—{C(O)—N(R)—X—[OC(O)—V—P(O)—(OY′)₂]_{y}}_{z},
wherein
   Rf is a monovalent or divalent perfluoropolyether group;
   each R is independently selected from the group consisting of hydrogen and alkyl having from 1 to 4 carbon atoms;
   each X is independently a divalent or trivalent group selected from the group consisting of alkylene, arylalkylene, and alkylarylene, wherein alkylene, arylalkylene, and alkylarylene are each optionally interrupted by at least one ether linkage;
   each V is independently alkylene that is optionally interrupted by at least one ether linkage or amine linkage;
   each Y′ is independently selected from the group consisting of hydrogen, alkyl, a counter cation, and a bond to the surface;
   y is 1 or 2; and
   z is 1 or 2.

In some embodiments of the foregoing aspects, the surface comprises at least one of metal, metal oxide, ceramic (i.e., glasses, crystalline ceramics, glass ceramics, and combinations thereof), natural stone, or a cementicious surface (e.g., grout, concrete, and engineered stone). In some embodiments of the foregoing aspects, the surface is on at least one of a faucet, a faucet handle, a sink, an oven range, an oven range hood, a countertop, flooring, or wall covering.

Compositions according to the present invention typically provide repellent properties to a variety of surfaces and improve the ability to clean these surfaces. For example, compositions according to the present invention can be used on metal surfaces to provide a durable treatment which allows removal of aqueous deposits (e.g., mineral deposits) with a wipe without the need for aggressive scrubbing and aggressive acidic cleaners; this treatment is typically, and surprisingly, more effective than other phosphonate-containing perfluoropolyethers that do not have an ester linkage (i.e., —O(CO)—).

In this application:

The terms “a”, “an”, and “the” are used interchangeably with “at least one”.

“Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

“Alkylene” refers to the divalent form or trivalent form of the “alkyl” groups defined above.

“Arylalkylene” refers to an “alkylene” moiety to which an aryl group is attached.

The term “aryl” as used herein includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

“Arylene” is the divalent form of the “aryl” groups defined above.

“Alkylarylene” refers to an “arylene” moiety to which an alkyl group is attached.

All numerical ranges are inclusive of their endpoints unless otherwise stated.

### DETAILED DESCRIPTION

Compositions according to the present invention are represented by Formula I

Rf—{C(O)—N(R)—X—[OC(O)—V—P(O)—(OY)₂]_{y}}_{z} I.

Rf is a monovalent or divalent perfluoropolyether group. The term “perfluoropolyether” refers to a compound or group having at least 10 (in some embodiments, at least 11, 12, 13, 14, 15, 16, 17, 18, 19, or even 20) carbon atoms and at least 3 (in some embodiments, at least 4, 5, 6, 7, or even 8) ether linkages, wherein the hydrogen atoms on the carbon atoms are replaced with fluorine atoms. In some embodiments, Rf has up to 100, 110, 120, 130, 140, 150, or even 160 carbon atoms and up to 25, 30, 35, 40, 45, 50, 55, or even 60 ether linkages.

Compositions according to the present invention may contain one perfluoropolyether group or a mixture of perfluoropolyether groups. Typically, the compositions will contain a mixture of perfluoropolyether groups.

The perfluoropolyether group Rf can be linear, branched, cyclic, or combinations thereof and can be saturated or unsaturated. Exemplary perfluoropolyethers include perfluorinated repeating units represented by at least one of —(C_{b}F_{2b})—, —(C_{b}F_{2b}O)—, —(CF(Z))—, —(CF(Z)O)—, —(CF(Z)C_{b}F_{2b}O)—, —(C_{b}F_{2b}CF(Z)O)—, or —(CF₂CF(Z)O)—. In these repeating units, b is typically an integer of 1 to 10. In some embodiments, b is an integer of 1 to 8, 1 to 6, 1 to 4, or 1 to 3. The Z group can be a perfluoroalkyl group optionally interrupted by at least one ether linkage or a perfluoroalkoxy group, each of which may be linear, branched, cyclic, or a combination thereof. The Z group typically has up to 12 (in some embodiments, up to 10, 8, 6, 4, 3, 2, or 1) carbon atoms. In some embodiments, the Z group can have up to 4 (in some embodiments, up to 3, 2, or 1) oxygen atoms; in some embodiments Z has no oxygen atoms. In these perfluoropolyether structures, different repeating units can be combined in a block or random arrangement to form the Rf group.

In some embodiments, Rf is a monovalent perfluoropolyether group (i.e., z is 1) represented by formula R_{f}^{a}—O—(R_{f}^{b}—O—)ₖ(R_{f}^{c})—, wherein R_{f}^{a} is a perfluoroalkyl having 1 to 10 (in some embodiments, 1 to 6, 1 to 4, 2 to 4, or 3) carbon atoms; each R_{f}^{b} is independently a perfluoroalkylene having 1 to 4 (i.e., 1, 2, 3, or 4) carbon atoms; R_{f}^{c} is a perfluoroalkylene having 1 to 6 (in some embodiments, 1 to 4 or 2 to 4) carbon atoms; and k is an integer from 2 to 50 (in some embodiments, 2 to 25, 2 to 20, 3 to 20, 3 to 15, 5 to 15, 6 to 10, or 6 to 8). Representative R_{f}^{a} groups include CF₃—, CF₃CF₂—, CF₃CF₂CF₂—, CF₃CF(CF₃)—, CF₃CF(CF₃)CF₂—, CF₃CF₂CF₂CF₂—, CF₃CF₂CF(CF₃)—, CF₃CF₂CF(CF₃)CF₂—, and CF₃CF(CF₃)CF₂CF₂—. In some embodiments, R_{f}^{a} is CF₃CF₂CF₂—. Representative R_{f}^{b} groups include —CF₂—, —CF(CF₃)—, —CF₂CF₂—, —CF(CF₃)CF₂—, —CF₂CF₂CF₂—, —CF(CF₃)CF₂CF₂—, —CF₂CF₂CF₂CF₂—, and —CF₂C(CF₃)₂—. Representative R_{f}^{c} groups include —CF₂—, —CF(CF₃)—, —CF₂CF₂—, —CF₂CF₂CF₂—, and CF(CF₃)CF₂—. In some embodiments, R_{f}^{c} is —CF(CF₃)—. In some embodiments, (R_{f}^{b}—O—)ₖ is represented by —[CF₂O]ᵢ[CF₂CF₂O]ⱼ—, —[CF₂O]ᵢ[CF(CF₃)CF₂O]ⱼ—, —[CF₂O]ᵢ[CF₂CF₂CF₂O]ⱼ—, —[CF₂CF₂O]ᵢ[CF₂O]ⱼ—, —[CF₂CF₂O]ᵢ[CF(CF₃)CF₂O]ⱼ—, —[CF₂CF₂O]ᵢ[CF₂CF₂CF₂O]ⱼ—, —[CF₂CF₂CF₂O]ᵢ[CF₂CF(CF₃)O]ⱼ—, and [CF₂CF₂CF₂O]ᵢ[CF(CF₃)CF₂O]ⱼ—, wherein i+j is an integer of at least 3 (in some embodiments, at least 4, 5, or 6) and up to 50 (in some embodiments, 40, 30, 20, or 10).

In some embodiments, z is 1, and Rf is selected from the group consisting of C₃F₇O(CF(CF₃)CF₂O)ₙCF(CF₃)—, C₃F₇O(CF₂CF₂CF₂O)ₙCF₂CF₂—, and CF₃O(C₂F₄O)ₙCF₂—, and wherein n has an average value in a range from 3 to 50 (in some embodiments, 3 to 25, 3 to 15, 3 to 10, 4 to 10, or even 4 to 7). In some of these embodiments, Rf is C₃F₇O(CF(CF₃)CF₂O)ₙCF(CF₃)—, wherein n has an average value in a range from 4 to 7. In some embodiments, Rf is selected from the group consisting of CF₃O(CF₂O)ₓ(C₂F₄O)_{y}CF₂— and F(CF₂)₃—O—(C₄F₈O)_{z}(CF₂)₃—, wherein x, y, and z each independently has an average value in a range from 3 to 50 (in some embodiments, 3 to 25, 3 to 15, 3 to 10, or even 4 to 10).

In some embodiments, Rf is a divalent perfluoropolyether group (i.e., z is 2). In some of these embodiments Rf is selected from the group consisting of —CF₂O(CF₂O)ᵣ(C₂F₄O)ₘCF₂—, —CF₂O(C₂F₄O)ₘCF₂—, —(CF₂)₃O(C₄F₈O)ₘ(CF₂)₃—, and —CF(CF₃)(OCF₂CF(CF₃))ₛOCₜF₂ₜO(CF(CF₃)CF₂O)ₘCF(CF₃)— where r can have an average value of 0 to 50, 1 to 50, 3 to 30, 3 to 15, or 3 to 10; m can have an average value of 0 to 50, 3 to 30, 3 to 15, or 3 to 10; s can have an average value of 0 to 50, 1 to 50, 3 to 30, 3 to 15, or 3 to 10; the sum of m and s (i.e., m+s) can have an average value of 0 to 50 or 4 to 40; the sum of r and m (i.e., r+m) is greater than 0; and t can be an integer of 2 to 6.

In some embodiments, Rf has a number average molecular weight of at least 500 (in some embodiments at least 600, 700, 750, 800, 900, or even 1000) grams per mole. In some embodiments, Rf has a number average molecular weight of up to 6000 (in some embodiments, 5000 or even 4000) grams per mole. In some embodiments, Rf has a number average molecular weight in a range from 750 grams per mole to 5000 grams per mole.

In Formula I, R is hydrogen or alkyl of 1 to 4 carbon atoms (e.g., methyl, ethyl, n-propyl, isopropyl, n-butyl, isobutyl, or sec-butyl). In some embodiments, R is hydrogen or methyl.

In Formula I, X is a divalent or trivalent group selected from the group consisting of alkylene, arylalkylene, and alkylarylene, wherein alkylene, arylalkylene, and alkylarylene are each optionally interrupted by at least one ether linkage (i.e., —O—). In some embodiments, X is alkylene. In some embodiments, X is ethylene. In some embodiments, X is methylene. In some embodiments, X is a divalent alkylene group, and y is 1. In some embodiments, X is a trivalent alkylene group, and y is 2.

In Formula I, V is alkylene that is optionally interrupted by at least one ether linkage (i.e., —O—) or amine (i.e., —N(R)—, wherein R is as defined above) linkage. In some embodiments, V is alkylene having from 2 to 4 (i.e., 2, 3, or 4) (in some embodiments, 2) carbon atoms.

In compositions according to the present invention, when at least one of y or z is 2, each Rf, R, X, and V group is independently selected.

In Formula I, each Y is independently selected from the group consisting of hydrogen, alkyl, and a counter cation. In some embodiments, each Y is hydrogen. In some embodiments, Y is alkyl group having 1 to 4 (i.e., 1, 2, 3, or 4) carbon atoms. In some embodiments, at least one Y is a counter cation. Exemplary counter cations include alkali metal (e.g., sodium, potassium, and lithium), ammonium, alkyl ammonium (e.g., tetraalkylammonium), and five to seven membered heterocyclic groups having a positively charged nitrogen atom (e.g, a pyrrolium ion, pyrazolium ion, pyrrolidinium ion, imidazolium ion, triazolium ion, isoxazolium ion, oxazolium ion, thiazolium ion, isothiazolium ion, oxadiazolium ion, oxatriazolium ion, dioxazolium ion, oxathiazolium ion, pyridinium ion, pyridazinium ion, pyrimidinium ion, pyrazinium ion, piperazinium ion, triazinium ion, oxazinium ion, piperidinium ion, oxathiazinium ion, oxadiazinium ion, and morpholinium ion).

The composition represented by Formula I can be prepared, for example, from a perfluoropolyether methyl ester of formula Rf—[C(O)—OCH₃]_{z}, wherein z is 1 or 2. Monovalent methyl esters of this formula can be prepared, for example, by polymerization of hexafluoropropylene oxide using known methods to form a perfluoropolyether terminated with a fluorocarbonyl group (i.e., —C(O)F). This material can be vacuum distilled to remove components having a molecular weight less than 500 (in some embodiments, less than 600, 700, 750, 800, 900, or even 1000) grams per mole. The fluorocarbonyl group can be converted to a alkoxycarbonyl group (e.g., a methyl ester) by conventional methods, for example, by esterification with methanol. Divalent methyl esters of formula Rf—[C(O)—OCH₃]_{z} can be prepared, for example, by known methods or can be obtained commercially (e.g., from Solvay Solexis, Houston, Tex., available under the trade designation “FOMBLIN ZDEAL”).

Methyl esters of formula Rf—[C(O)—OCH₃]_{z} can then be reacted, for example, with an amino alcohol of Formula NHR—X—(OH)_{y}, wherein R, X, and y are as defined above, using methods described on column 16, lines 37-62 of U.S. Pat. No. 7,094,829 (Audenaert et al.), the disclosure of which method is incorporated herein by reference, to provide an alcohol of formula Rf—[C(O)—NHR—X—(OH)_{y}]_{z}. Many amino alcohols are available commercially. In some embodiments, the amino alcohol is ethanol amine. In some embodiments, the amino alcohol is 3-amino-1,2-propanediol.

Alcohols of formula Rf—[C(O)—NHR—X—(OH)_{y}]_{z} can be reacted, for example, with a phosphono carboxylic acid, or an ester or a salt thereof, of formula HOOC—V—P(O)—(OY)₂, wherein V and Y as are defined above, under esterification conditions to provide a compound of Formula I. In some embodiments, the phosphono carboxylic acid is 2-phosphonoacetic acid or 3-phosphonopropionic. The reaction may be carried out, for example, at an elevated temperature, in a suitable solvent (e.g., a ketone or an ether), optionally in the presence of a catalyst (e.g., methanesulfonic acid).

In some embodiments of formulations according to the present invention, the formulation comprises a composition represented by Formula I and an aliphatic phosphonic acid, or an ester or a salt thereof. The aliphatic phosphonic acid, or an ester or a salt thereof, has from 1 to 30 (in some embodiments, 1 to 25, 1 to 20, 1 to 10, 4 to 25, 8 to 25, or even 12 to 25) carbon atoms and optionally at least one ether linkage (i.e., —O—), ester linkage (i.e., —O—C(O)— or —C(O)—O—), or amide linkage (i.e., —N(R)—C(O)— or —C(O)—N(R)—, wherein R is as defined above). In some embodiments, the aliphatic phosphonic acid, or an ester or a salt thereof, is represented by formula:

CₚH₂ₚ₊₁OC(O)C_{q}H_{2q+1}P(O)—(OY)₂,
wherein
   each Y is independently selected from the group consisting of hydrogen, alkyl, and a counter cation;
   p is an integer from 10 to 30; and
   q is an integer from 1 to 5.

Aliphatic phosphonic acids, and esters and salts thereof, can be obtained from commercial sources or can be prepared using known synthetic methods. Compounds of formula CₚH₂ₚ₊₁OC(O)C_{q}H_{2q+1}P(O)—(OY)₂ can be prepared from alcohols of formula CₚH₂ₚ₊₁OH and compounds of formula HOOC—V—P(O)—(OY)₂ using methods described above for the preparation of composition of Formula I.

In some embodiments of formulations according to the present invention, the formulation comprises a composition of Formula I and solvent. In some embodiments, the solvent comprises at least one of a lower alcohol (e.g., methanol, ethanol, n-propanol, isopropanol, n-butanol, s-butanol, and isobutanol) or a hydrofluoroether.

In some embodiments, the solvent is a hydrofluoroether. Suitable hydrofluoroethers can be represented by the following general Formula II:

R_{f}¹O—Rₕₐ II

where a is an integer of 1 to 3, R_{f}¹ is a monovalent, divalent, or trivalent perfluoroalkyl, that is linear, branched, cyclic, or combinations thereof and that is optionally interrupted by at least one ether linkage (i.e., —O—); and Rₕ an alkyl group that is linear, branched, cyclic, or combinations thereof and optionally contains at least one heteroatom (e.g., N, O, or S). For example, the hydrofluoroether can be methyl perfluorobutyl ether or ethyl perfluorobutyl ether.

In some embodiments of methods and/or articles of the present invention, compositions according to the present invention are applied to and/or are in contact with a surface. In some embodiments, the surface is metal (including metals and metal alloys). The metal is typically solid at room temperature. For some embodiments, the metal and/or metal alloy is selected from the group consisting of chromium, chromium alloys, iron, aluminum, copper, nickel, zinc, tin, stainless steel, and brass. In some embodiments, the metal and/or metal alloy comprises at least one of gold, platinum, chromium, aluminum, copper, silver, titanium, indium, germanium, tin, nickel, indium tin. In some embodiments, the surface comprises stainless steel. In some embodiments, the surface comprises at least one of chromium or chromium oxide. In some embodiments, the surface comprises at least one of a metal or metal oxide, and the compound forms at least a partial monolayer on the surface. For some embodiments, a major surface of the metal substrate comprises chromium. An article with a metal surface may comprise other materials (e.g., under the metal surface) which include thermoset and thermoplastic polymers, ceramic, porcelain, as well as other materials capable of having a metallized surface. Examples of articles having metal surfaces include kitchen and bathroom faucets, taps, handles, spouts, sinks, drains, hand rails, towel holders, curtain rods, dish washer panels, refrigerator panels, stove tops, stove, oven, and microwave panels, exhaust hoods, grills, and metal wheels or rims.

Metal substrates and metallized substrates are found in a variety of environments, including kitchens and bathrooms, as well as outdoor areas, where they can come in contact with aqueous residues such as food, soap, and minerals (e.g., lime). Removing such deposits from, for example, faucets, shower heads, and hand rails, often requires aggressive scrubbing, frequently with acidic cleaners or detergents, and often challenge the esthetic appearance and durability of the surface of these substrates. Compositions, methods, and articles according to the present invention typically provide easy-to-clean metal surfaces, which allow removal of aqueous deposits (e.g., mineral deposits) with a wipe without the need for aggressive scrubbing and without the need for aggressive acidic cleaners and which retain this property with repeated wipes. The easy-to-clean properties provided by the compositions according to the present invention are surprisingly better than those provided by other phosphonate-containing perfluoropolyethers reported in U.S. Pat. App. Pub. No. 2005/0048288 (Flynn et al.). Since compositions according to the present invention can render metal surfaces resistant to soils, the optical properties of metal surfaces like those on decorative metal strips and mirrors can be preserved longer.

The compositions of the present invention can be applied to a wide variety of substrates, which may result in an article that displays stain-release properties. These substrates include hard substrates and fibrous substrates. Hard substrates include rigid and non-rigid substrates and include ceramic (including glass), masonry, concrete, natural stone, man-made stone, metals, wood, plastics, and painted surfaces. Fibrous substrates include woven, knit, and nonwoven fabrics, textiles, carpets, leather, and paper. Substrates can have flat or curved surfaces and may be particulate and fibrous in nature, as well. In some embodiments, substrates (including hard substrates) are capable of imbibing a liquid and are therefore porous. Such substrates are particularly subject to staining and soiling, but can benefit from the chemical compositions of the present invention because the coating composition can penetrate into the porous substrate surface. Without wanting to be bound by theory, it is believed that substrates comprising nucleophilic groups selected from the group consisting of —OH and —NHR, wherein R is H or lower alkyl can bond to the phosphonate groups of the chemical compositions of the present invention, typically increasing durability. Substrates of this type include those having siliceous and metallic surfaces.

Representative examples of articles that can be coated with compositions according to the present invention include lenses used in ophthalmic spectacles, sunglasses, optical instruments, illuminators, and watch crystals; glass panels (e.g., automotive glass); plastic window glazing; signs; decorative surfaces such as wallpaper and vinyl flooring; composite or laminated substrates (e.g., sheeting available from Formica Corporation, Cincinnati, Ohio under the trade designation “FORMICA” and flooring available, for example, from Pergo, Raleigh, N.C. under the trade designation “PERGO”); ceramic tile and fixtures (e.g., sinks, showers, and toilets); natural and man-made stones; decorative and paving stones (e.g., marble, granite, limestone, and slate); cement and stone sidewalks and driveways; particles that comprise grout or the finished surface of applied grout; wood furniture surface (e.g., desktops and tabletops); cabinet surfaces; wood flooring, decking, and fencing; leather; paper; fiber glass fabric and other fiber-containing fabrics; textiles; and carpeting.

The compositions can make wood surfaces more resistant to food and beverage stains while helping to maintain a lustrous appearance. In addition, the compositions can be applied as a protective coating on aircraft wings, boat hulls, fishing line, medical surfaces, and siding, and can be used in food release, mold release, and adhesive release applications.

In methods according to the present invention, a surface is contacted with a composition according to the present invention. In some embodiments, the composition is present in a formulation comprising at least one of solvent or water. In some embodiments, the solvent comprises at least one of a hydrofluoroether or a lower alcohol (e.g., methanol, ethanol, propanol, isopropanol, isobutanol, butanol, sec-butanol). In some embodiments, the formulation comprises water. In these embodiments, the formulation may also include solvent. In some embodiments wherein the formulation comprises water, it further comprises at least one of a nonionic or anionic surfactant. Suitable surfactants include those described in U.S. Pat. No. 6,995,222 (Buckanin et al.), the disclosure of which, relating to its description of surfactants, is incorporated herein by reference.

Typically, formulations according to the present invention include from at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.5, 1, 1.5, 2, 3, 4, or 5 percent by weight, up to 5, 6, 7, 8, 9, or 10 percent by weight of at least one composition according to the present invention, based on the total weight of the formulation. For example, the amount of the composition may be in a range of from 0.01 to 10; 0.1 to 10, 0.1 to 5, 1 to 10, or even in a range from 1 to 5 percent by weight, based on the total weight of the formulation. In some embodiments of formulations comprising water, compositions according to the present invention are present at 0.1 to 5%, 1.5% to 5%, 2% to 5%, or 0.5 to 3%, based on the total weight of the formulation. Lower and higher amounts of the compositions may also be used, and may be desirable for some formulations and applications.

In some embodiments of methods of treating a surface according to the present invention, the composition is allowed to dry for about 1 to 24 (in some embodiments, 4 to 24 or even 8 to 24) hours. In some embodiments, the drying takes place at ambient temperature (e.g., 15 to 35° C.). In some embodiments, the composition is dried at elevated temperature (e.g., 50° C. to 150° C., or even 50° C. to 100° C.). Without wanting to be bound by theory, it is believed that during the drying time and over a subsequent period of time, compositions according to the present invention can form chemical bonds with the substrate and/or between molecules of the chemical composition.

In methods according to the present invention, any method of application of compositions according to the present invention on a surface may be used. Examples of useful application methods include spraying (e.g., with a spray bottle), padding, dipping (i.e., immersing the substrate in a formulation), spin-coating, flow coating, vacuum coating, painting, and wiping (e.g., with a sponge or cloth). When treating flat substrates of appropriate size, knife-coating or bar-coating may be used to ensure uniform coatings on a substrate.

Coatings of compositions according to and/or useful in practicing the present invention can be applied to a substrate in any desired thickness. Coatings as thin as 20 (in some embodiments, 30, 40, or 50) nanometers up to 5 (in some embodiments, 4, 3, 2, or 1) micrometers can offer excellent low surface energy, stain-resistance, and/or stain-release. Thicker coatings (e.g., in the range of 1 to 5 micrometers) can be obtained by applying to the substrate a single thicker layer of a coating composition that contains a relatively high concentration of the chemical composition of the present invention. Thicker coatings can also be obtained by applying successive layers to the substrate of a coating composition that contains a relatively low concentration of the chemical composition of the present invention. The latter can be done by applying a layer of the coating composition to the substrate and then drying prior to application of a successive layer. Successive layers of the coating can then be applied to dried layers. This procedure can be repeated until the desired coating thickness is achieved.

Articles according to the present invention, having a surface in contact with a composition according to the present invention have typically been found to be at least one of non-staining, stain-releasing with simple washing methods, oil resistant (e.g., resistant to fingerprints), resistant to lime deposits, or resist being worn-off due to wear and abrasion from use, cleaning, and the elements.

Embodiments and advantages of this invention are further illustrated by the following non-limiting examples, but the particular materials and amounts thereof recited in these examples, as well as other conditions and details should not be construed to unduly limit this invention.

Unless otherwise noted, all parts, percentages, ratios, etc. in the examples and the rest of the specification are by weight.

### EXAMPLES

In the following examples, all reagents were obtained from Sigma-Aldrich, St. Louis, Mo. unless indicated otherwise. All percentages and ratios reported are by weight unless indicated otherwise.

### Preparation of C₃F₇O(CF(CF₃)CF₂O)ₖCF(CF₃)C(O)NHCH₂CH₂OH

C₃F₇O(CF(CF₃)CF₂O)ₖCF(CF₃)COOCH₃ was prepared essentially as described in U.S. Pat. No. 6,995,222 (Buckanin et al.), Preparative Example 1, the disclosure of which example is incorporated herein by reference, as a mixture containing 0.002% k=2, 5.9% k=3, 25.2% k=4, 27% k=5, 20.7% k=6, 12.4% k=7, 5.4% k=8, 1.8% k=9, and 0.5% k=10 as determined by gas/liquid chromatography and gas/liquid chromatography/mass spectrometry, and having a number average molecular weight of 1232 grams per mole as calculated from the chromatography data.

C₃F₇O(CF(CF₃)CF₂O)ₖCF(CF₃)COOCH₃ was treated with 2-aminoethanol as described in column 16, lines 37-62 of U.S. Pat. No. 7,094,829 (Audenaert et al.), the disclosure of which is incorporated herein by reference, to provide C₃F₇O(CF(CF₃)CF₂O)ₖCF(CF₃)C(O)NHCH₂CH₂OH.

C₃F₇O(CF(CF₃)CF₂O)ₖCF(CF₃)COOCH₃ was treated with 3-amino-1,2-propanediol instead of 2-aminoethanol using the method described in column 16, lines 37-62 of U.S. Pat. No. 7,094,829 (Audenaert et al.) to provide C₃F₇O(CF(CF₃)CF₂O)ₖCF(CF₃)C(O)NHCH₂CH(OH)CH₂OH.

### Example 1

In a 500-mL 3-necked flask equipped with a mechanical stirrer, a Dean-Stark trap condenser, and a thermometer, 126.1 grams (0.1 mole) of C₃F₇O(CF(CF₃)CF₂O)ₖCF(CF₃)C(O)NHCH₂CH₂OH, 14 grams (0.1 mole) 2-phosphonoacetic acid, 40 grams of methyl isobutyl ketone (MIBK), and 0.5 grams of methanesulfonic acid were combined. The reaction was heated at reflux for 6 hours. During this time about 1.8 grams of water were collected in the Dean-Stark trap. The MIBK was removed under vacuum. The product was analyzed by ¹H, ¹⁹F, and ³¹P nuclear magnetic resonance spectroscopy, and the data were consistent with a product having the structure C₃F₇O(CF(CF₃)CF₂O)ₖCF(CF₃)C(O)NHCH₂CH₂OC(O)CH₂P(O)(OH)₂. The product was diluted to 0.1% with isopropanol for evaluation.

### Example 2

Example 2 was prepared as described in Example 1 except using 3-phosphonopropionic acid (0.1 mole) instead of 2-phosphonoacetic acid. The product, C₃F₇O(CF(CF₃)CF₂O)ₖCF(CF₃)C(O)NHCH₂CH₂OC(O)CH₂CH₂P(O)(OH)₂, was diluted to 0.1% with a hydrofluoroether, obtained from 3M Company, St. Paul, Minn. under the trade designation “HFE-7200”, for evaluation.

### Example 3

Example 3 was prepared as described in Example 1 except using C₃F₇O(CF(CF₃)CF₂O)ₖCF(CF₃)C(O)NHCH₂CH(OH)CH₂OH instead of C₃F₇O(CF(CF₃)CF₂O)ₖCF(CF₃)C(O)NHCH₂CH₂OH and using 0.2 mole of 2-phosphonoacetic acid. The product, C₃F₇O(CF(CF₃)CF₂O)ₖCF(CF₃)C(O)NHCH₂CH[OC(O)CH₂P(O)(OH)₂]CH₂OC(O)CH₂—P(O)(OH)₂, was diluted to 0.1% with isopropanol for evaluation.

### Example 4

Example 4 was prepared as described in Example 1 except using C₃F₇O(CF(CF₃)CF₂O)ₖCF(CF₃)C(O)NHCH₂CH(OH)CH₂OH instead of C₃F₇O(CF(CF₃)CF₂O)ₖCF(CF₃)C(O)NHCH₂CH₂OH and using 3-phosphonopropionic acid (0.2 mole) instead of 2-phosphonoacetic acid. The product, C₃F₇O(CF(CF₃)CF₂O)ₖCF(CF₃)C(O)NHCH₂CH[OC(O)CH₂CH₂P(O)(OH)₂]CH₂OC(O)—CH₂CH₂P(O)(OH)₂, was diluted to 0.1% with isopropanol for evaluation.

### Example 5

Example 5 was prepared as described in Example 1 except using behenyl alcohol (C₂₂H₄₅OH) instead of C₃F₇O(CF(CF₃)CF₂O)ₖCF(CF₃)C(O)NHCH₂CH₂OH and 3-phosphonopropionic acid instead of 2-phosphonoacetic acid and with the modification that the resulting material was combined with the material from Example 2 in a 50/50 weight ratio, and the mixture was diluted to 0.1% with isopropanol for evaluation.

### Comparative Example

The method described in Example 2 of U.S. Pat. App. Pub. No. 2005/0048288 (Flynn et al.) was used to prepare a comparative example of formula:

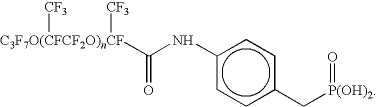

The product was diluted to 0.1% with hydrofluoroether “HFE-7200”, for evaluation.

### Evaluation of Examples 1 to 5

The substrates used to test Examples 1-5 and the Comparative Example were obtained from Ideal Standard, Wittlich, Germany and were metal fittings with a layer of electroplated chromium on the surface.

The substrates were cleaned by dipping for 15 minutes at 70° C. in a 10% sodium hydroxide solution. The substrates were rinsed thoroughly with water, dried, and cleaned with acetone and a hydrofluoroether obtained from 3M Company under the trade designation “HFE-7100”. The solutions of Examples 1, 3, 4, and 5 were applied to the substrates by spray application (2 bar (2×10⁵ Pa) and 20 mL/minute). The solution of Example 2 and the Comparative Example were applied to the substrates using a saturated paper wipe. The substrates were dried at room temperature and heated to 70° C. for 5 minutes and allowed to stand at room temperature for 24 hours before testing. Static contact angles were measured versus water and hexadecane on the substrates treated with Examples 1 to 5, the Comparative Example, and an untreated substrate using an Olympus model TGHM goniometer (obtained from Olympus Corporation of America, Pompano Beach, Fla.). An abrasion test was carried out by wiping with a wipe (obtained from 3M Company under the trade designation “3M HIGH PERFORMANCE WIPE”) 200 times. Static contact angles were measured again after the abrasion test. For contact angles measurements, the mean values of 3 measurements and are reported in degrees in the Table (below).

TABLE

| | Initial contact | Contact angle after | Hard-water |
|---|---|---|---|
| | angle | abrasion | cleanability |
| Treatment | Water/hexadecane | Water/hexadecane | rating |
| No treatment | 42-55/<20 | 40/<20 | 1 |
| Example 1 | 115/72 | 92/55 | 8 |
| Example 2 | 114/74 | 94/50 | 8 |
| Example 3 | 98/65 | 85/51 | 7 |
| Example 4 | 95/64 | 83/48 | 7 |
| Example 5 | 110/71 | 88/52 | 8 |
| Comparative | 98/70 | 72/40 | 5 |
| Example | | | |

The cleanability of the fittings treated with solutions of Examples 1 to 5, the Comparative Example, and an untreated substrate was carried out by applying mineral water (obtained from Tonissteiner, Germany). The water was sprayed at 0.5 bar (5×10⁴ Pa) at room temperature until the substrate was completely covered. The substrate was placed in an oven for two hours at 70° C., removed, and allowed to cool. Limestone deposits were present on the substrates, which were then cleaned with a dry paper wipe. The cleaning results were evaluated visually and rated on a scale of 0 (no visible removal of the deposits) to 10 (no visible marks left after 3 wipes). The results are shown in the Table (above).

Various modifications and alterations of this invention may be made by those skilled in the art without departing from the scope and spirit of this invention, and it should be understood that this invention is not to be unduly limited to the illustrative embodiments set forth herein.

1. A composition represented by formula:
Rf—{C(O)—N(R)—X—[OC(O)—V—P(O)—(OY)₂]_{y}}_{z},
wherein
Rf is a monovalent or divalent perfluoropolyether group;
each R is independently selected from the group consisting of hydrogen and alkyl having from 1 to 4 carbon atoms;
each X is independently a divalent or trivalent group selected from the group consisting of alkylene, arylalkylene, and alkylarylene, wherein alkylene, arylalkylene, and alkylarylene are each optionally interrupted by at least one ether linkage;
each V is independently alkylene that is optionally interrupted by at least one ether linkage or amine linkage;
each Y is independently selected from the group consisting of hydrogen, alkyl, and a counter cation;
y is 1 or 2; and
z is 1 or 2.

2. The composition according to claim 1, wherein Rf has a number average molecular weight in a range from 750 grams per mole to 5000 grams per mole.

3. The composition according to claim 1, wherein Rf is selected from the group consisting of C₃F₇O(CF(CF₃)CF₂O)ₙCF(CF₃)—, C₃F₇O(CF₂CF₂CF₂O)ₙCF₂CF₂—, and CF₃O(C₂F₄O)ₙCF₂—, wherein n has an average value of 3 to 50, and wherein z is 1.

4. The composition according to claim 1, wherein Rf is C₃F₇O(CF(CF₃)CF₂O)ₙCF(CF₃)—, and wherein n has an average value of 4 to 7.

5. The composition according to claim 1, wherein X is a divalent alkylene group, and wherein y is 1.

6. The composition according to claim 1, wherein X is a trivalent alkylene group, and wherein y is 2.

7. A formulation comprising the composition according to claim 1 and an aliphatic phosphonic acid, or an ester or a salt thereof, having from 1 to 30 carbon atoms and optionally at least one ether linkage, ester linkage, or amide linkage.

8. The formulation according to claim 7, wherein the aliphatic phosphonic acid, or an ester or a salt thereof, is represented by formula:
CₚH₂ₚ₊₁OC(O)C_{q}H_{2q+1}P(O)—(OY)₂,
wherein
each Y is independently selected from the group consisting of hydrogen, alkyl, and a counter cation;
p is an integer from 10 to 30; and
q is an integer from 1 to 5.

9. A formulation comprising a composition according to claim 1 and solvent, wherein the solvent comprises at least one of water, a lower alcohol, or a hydrofluoroether.

10. A method of treating a surface, the method comprising contacting the surface with a composition according to claim 1.

11. The method according to claim 10, wherein the surface comprises at least one of metal, metal oxide, ceramic, natural stone, or a cementicious surface.

12. The method according to claim 10, wherein the surface comprises at least one of stainless steel, chromium, or chromium oxide.

13. (canceled)

14. The method according to claim 10, wherein the composition is present in a formulation comprising solvent, wherein the solvent comprises at least one of a lower alcohol, a hydrofluoroether, or water.

15. (canceled)

16. An article having a surface, wherein at least a portion of the surface is in contact with a composition represented by formula:
Rf—{C(O)—N(R)—X—[OC(O)—V—P(O)—(OY′)₂]_{y}}_{z},
wherein
Rf is a monovalent or divalent perfluoropolyether group;
each R is independently selected from the group consisting of hydrogen and alkyl having from 1 to 4 carbon atoms;
each X is independently a divalent or trivalent group selected from the group consisting of alkylene, arylalkylene, and alkylarylene, wherein alkylene, arylalkylene, and alkylarylene are each optionally interrupted by at least one ether linkage;
each V is independently alkylene that is optionally interrupted by at least one ether linkage or amine linkage;
each Y′ is independently selected from the group consisting of hydrogen, alkyl, a counter cation, and a bond to the surface;
y is 1 or 2; and
z is 1 or 2.

17. The article according to claim 16, wherein the surface comprises at least one of metal, metal oxide, ceramic, natural stone, or a cementicious surface.

18. (canceled)

19. The article according to claim 16, wherein the surface comprises at least one of stainless steel, chromium, or chromium oxide.

20-21. (canceled)

22. The article according to claim 16, wherein Rf has a number average molecular weight in a range from 750 grams per mole to 5000 grams per mole.

23. The article according to claim 16, wherein Rf is C₃F₇O(CF(CF₃)CF₂O)ₙCF(CF₃)—, and wherein n has an average value of 4 to 7.

24. The article according to claim 16, wherein X is a divalent alkylene group, and wherein y is 1.

25. The article according to claim 16, wherein X is a trivalent alkylene group, and wherein y is 2.
